(19) United States
(12) Patent Application Publication
(10) Pub. No.: US 2026/0268627 A1
(43) Pub. Date: Sep. 10, 2026

(54) VIDEO MEDICAL RECORDS

(71) Applicant: Ronin Surgical Corp., Austin, TX (US)

(72) Inventors: Clifton Learn, Austin, TX (US); Jeff Ross Gray, San Diego, CA (US)

(73) Assignee: Ronin Surgical Corp., Austin, TX (US)

(21) Appl. No.: 19/556,942

(22) Filed: Mar. 4, 2026

Related U.S. Application Data
(60) Provisional application No. 63/766,595, filed on Mar. 4, 2025.

(51) Int. Cl. G16H 30/40; G16H 30/20

(52) U.S. Cl. CPC G06V 10/245; G06V 10/22; G06V 10/25; G06V 10/40; G06V 20/46; G06V 2201/03

(57) ABSTRACT

Systems and methods of creating a redacted video of a surgical procedure are disclosed. A method of redacting a source video comprising steps receiving a frame of the source video, identifying with an image-identification algorithm a machine-identifiable marker within the received frame of the source video, retrieving information comprising a description of an area of exclusion and a spatial relationship of the identified marker to the area of exclusion, identifying with an image-processing algorithm a portion of the received frame of the source video that corresponds to the area of exclusion, and creating an output frame of a redacted video that corresponds to the received frame of the source video by obscuring the identified portion of the received frame of the source video.

### CROSS REFERENCE TO RELATED APPLICATIONS

This application claims priority to, and the benefit of, U.S. Provisional Application No. 63/766,595, entitled “VIDEO MEDICAL RECORDS” and filed Mar. 4, 2025, the disclosure of which is herein incorporated by this reference in its entirety.

### FIELD

This disclosure relates to editing of video recordings of medical procedures and, in particular, redaction of personal health information.

### BACKGROUND

It is often desirable to record medical procedures as part of a patient's medical record or for training purposes. Video recordings are commonly captured using a hand-held camera or a head-mounted camera worn by a surgeon.

Compliance with the Health Insurance Portability and Accountability Act (HIPAA) is conventionally accomplished in post-surgical processing of the raw video by manually selecting areas of each frame that contain visible protected health information (PHI), e.g., a procedure display in the operating room (OR), or visual identifiers specific to the patient, e.g., tattoos, birthmarks, and scars. This is a laborious and time-consuming process and does not support sharing the video in real-time.

In view of the above, there is a need for improved methods and systems for video medical records.

### SUMMARY

The systems and methods disclosed herein can automatically generate a redacted video from the raw source video feed from a camera. This can be accomplished in near-real-time or as a post-processing step from a stored video recording.

The systems and methods disclosed herein can automatically generate a focused output video from the raw source video feed from a camera. This can be accomplished in near-real-time or as a post-processing step from a stored video recording.

The systems and methods disclosed herein can generate a stabilized output video from the raw source video feed from a camera. This can be accomplished in near-real-time or as a post-processing step from a stored video recording.

Various embodiments can include a method of redacting a source video. The method can include receiving a frame of the source video, identifying with an image-identification algorithm a marker within the frame of the source video, retrieving information comprising a description of an area of exclusion and a spatial relationship of the marker to the area of exclusion, identifying with an image-processing algorithm a portion of the frame of the source video that corresponds to the area of exclusion, and/or creating an output frame of a redacted video that corresponds to the frame of the source video by obscuring the portion of the frame of the source video. The marker can be machine-identifiable.

Various embodiments can include a machine-readable, non-volatile memory. The memory can include instructions that, when loaded into a processor and executed, cause the processor to perform the steps of receiving a frame of a source video, identifying with an image-identification algorithm a marker within the frame of the source video, retrieving information comprising a description of an area of exclusion and a spatial relationship of the marker to the area of exclusion, identifying with an image-processing algorithm a portion of the frame of the source video that corresponds to the area of exclusion, and/or creating an output frame of a redacted video that corresponds to the frame of the source video by obscuring the portion of the frame of the source video. The marker can be machine-identifiable.

Various embodiments can include a method of maintaining focus of a designated site in a video record. The method can include receiving a plurality of source videos from a respective plurality of cameras each having a different focal range, each source video including a chronological series of frames each having a corresponding time stamp, identifying a frame of each of the plurality of source videos that corresponds to a selected time stamp, calculating a focal metric for each of the identified frames of the plurality of source videos, determining which of the identified frames has a desired focal metric, and/or saving the determined frame as part of the video record.

Various embodiments can include a method of stabilizing a video record. The method can include receiving a source video including a chronological series of source frames, selecting from the source video a set of source frames to be stabilized, identifying a position of a tracking feature in each source frame of the set of source frames, selecting an output frame for each source frame in the set of source frames such that the position of the tracking feature is the same within each output frame, and/or saving the selected output frames as part of the video record. The set of source frames can be chronologically sequential.

### BRIEF DESCRIPTION OF THE DRAWINGS

Aspects of the disclosure are herein described, by way of example only, with reference to the accompanying drawings. With specific reference now to the drawings in detail, it is stressed that the particulars shown are by way of example and are for purposes of illustrative discussion of aspects of the disclosure. The description and the drawings, considered alone and together, make apparent to those skilled in the art how aspects of the disclosure may be practiced.

FIG. 1 depicts a conventional camera system that comprises a commercially-available video camera mounted to a headband worn by a surgeon.

FIG. 2 depicts an operation in progress in an OR with multiple displays disposed around the operating table to provide information to the surgeon and staff during the operation, in accordance with the present disclosure.

FIG. 3 depicts a camera system attached to a pair of protective glasses, in accordance with the present disclosure.

FIG. 4A depicts a draped surgical site with exemplary markers disposed proximate to the site, in accordance with the present disclosure.

FIG. 4B depicts a draped patient with an exemplary boundary marker, in accordance with the present disclosure.

FIG. 5 depicts an operation in progress with exemplary markers disposed on equipment, staff, and the patient, in accordance with the present disclosure.

FIG. 6 depicts exemplary areas of exclusion respectively associated with markers and/or the orientation of the camera, in accordance with the present disclosure.

FIGS. 7A-7B depict an exemplary marker disposed at different distances from the camera and configured to enable image analysis to determine the distances, in accordance with the present disclosure.

FIG. 8 schematically depicts the relationship between a source video, a mask, and a redacted video, in accordance with the present disclosure.

FIG. 9 is a block diagram of an exemplary system configured to capture raw video and create a redacted video, in accordance with the present disclosure.

FIG. 10 is a flowchart of an exemplary process to capture raw video and create a redacted video, in accordance with the present disclosure.

FIGS. 11A-11D depict exemplary focus targets, in accordance with the present disclosure.

FIG. 12 depicts an exemplary process of stabilizing a video, in accordance with the present disclosure.

### DETAILED DESCRIPTION

This description is intended to illustrate some particular embodiments of the disclosure and not to exhaustively specify all permutations, combinations and variations thereof. Features illustrated with respect to one embodiment may be incorporated into other embodiments, and features illustrated with respect to a particular embodiment may be deleted from that embodiment. In addition, numerous variations and additions to the various embodiments suggested herein will be apparent to those skilled in the art in light of the instant disclosure and do not depart from the instant disclosure. In some instances, well-known structures, interfaces, and processes have not been shown in detail in order not to unnecessarily obscure the invention. It is intended that no part of this specification be construed to effect a disavowal of any part of the full scope of the invention.

Unless otherwise defined herein, all technical and scientific terms used herein have the same meaning as commonly understood by one of ordinary skill in the art to which this disclosure belongs. The terminology used in the description of the disclosure herein is for the purpose of describing particular aspects or embodiments only and is not intended to be limiting of the disclosure. References to techniques employed herein are intended to refer to the techniques as commonly understood in the art, including variations on those techniques or substitutions of equivalent techniques that would be apparent to one of skill in the art.

### Definitions

As used within this disclosure, the term “light” means electromagnetic energy having a wavelength within the range, or band, of 10 nm to 1 mm, wherein “visible” light is generally associated with the range of 380-750 nm also referred to as the visible spectrum, “infrared” (IR) light is generally associated with the range of 750 nm-1 mm that is also referred to as the IR light band, and “near infrared” (near-IR) is generally associated with the range of 750-1500 nm that is also referred to as the near-IR band, and ultraviolet (UV) light is generally associated with the range of 10-380 nm.

As used within this disclosure, the term “optical” refers to aspects of elements that manipulate any portion of the full frequency band of light as defined herein.

As used within this disclosure, the term “camera” and phrases “video recorder” and “video capture device” are used interchangeably to refer to an imaging device that has a FOV and provides a video signal comprising an encoded image. The video signal comprises one or more of a single frame and a video comprising multiple time-sequential frames of images of objects and people within the FOV. A video signal may have the form of a time-varying digital or analog electrical or optical signal, e.g., a real-time video signal passing from a camera to a storage device, a stored digital representation of the video signal, e.g., a non-volatile digital computer file that comprises the information of the video signal, or a digital data structure that comprises the information of the video signal while being processed, digitally manipulated, or stored in an volatile memory, e.g., RAM linked to a processor. A video signal explicitly does not include a displayed reconstruction of a portion of the FOV, e.g., a picture displayed on a monitor, or a hardcopy of a portion of the FOV, e.g., a photograph.

As used within this disclosure, the term “frame” means a portion of the video signal that corresponds to a FOV captured entirely at a single time. A frame explicitly does not include a displayed reconstruction of a portion of the FOV, e.g., a picture displayed on a monitor, or a hardcopy of a portion of the FOV, e.g., a photograph.

As used within this disclosure, the phrase “raw video” means the unmodified video signal provided by a video capture device, including video that has been compressed with lossy compression technology, e.g., MPEG-4, DV and HDV, and AVCHD.

As used within this disclosure, the phrase “source video” means a video signal that has not yet been redacted to obscure PHI. A source video may be any of a raw video, a stored video, or an edited video.

As used within this disclosure, the phrase “machine-readable code” means an optically detectable pattern that is associated with information, i.e., a linear or 2D barcode, an arrangement of one or more colored areas, or an arrangement of one or more optical patterns such as stripes or checkboard.

As used within this disclosure, the term “obscure” means modifying a defined portion of a video image to reduce the detail of the image within the defined portion thereby making it more difficult to make out details such as text or recognizable features of people or objects within the image. This includes but is not limited to blurring the image, combining pixels to create a larger pixel size for the image, and/or covering a portion of the image with a solid or patterned geometric shape. In certain embodiments, the area to be obscured is overlaid at least in part with an “avatar,” e.g., a portion of a generic humanoid figure, to provide a reference to the observer while blocking PHI or personally identifiable characteristics. For example, a redacted video of an operation may overlay an avatar face over the face of the actual patient.

As used within this disclosure, the phrase “spatial location” means a position and/or orientation of an object that is defined relative to a reference point in at least one of the six conventional degrees of freedom (DOF). In certain embodiments, the spatial location has an implied relationship to the reference point in one or more of the DOF, e.g., the object is a 2D area that is implicitly co-planar with a planar reference target.

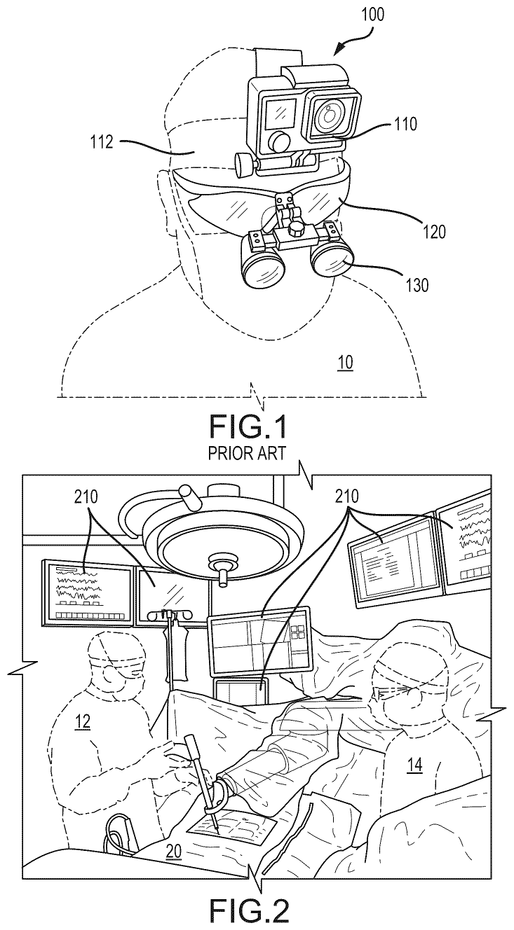

FIG. 1 depicts a conventional camera system 100 that comprises a commercially-available video camera 110 that is mounted to a headband 112 worn by a surgeon 10. In the example shown, the surgeon 10 is also wearing protective glasses 120 with surgical magnifiers 130.

FIG. 2 depicts an operation in progress in an OR with multiple displays 210 disposed around the operating table to provide information to the surgeon 12 and staff member 14 during an operation on a patient 20, in accordance with the present disclosure. In certain circumstances, some of the information displayed on one or more of the displays 210 is considered PHI associated with the patient 20. In certain situations, a video record of the procedure that is made available to people not participating in the operation may desirably have the PHI redacted, e.g., obscured or otherwise removed from the video.

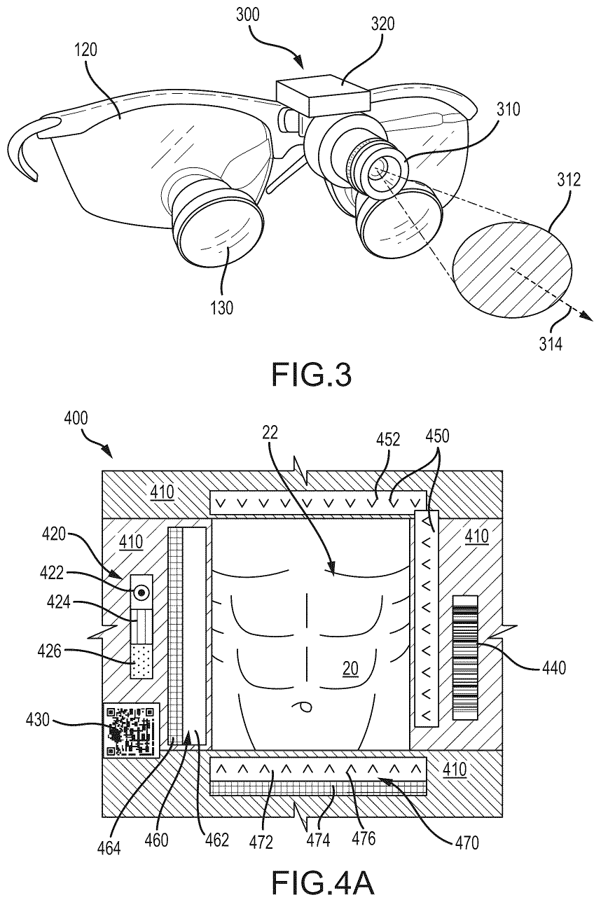

FIG. 3 depicts a camera system 300 attached to a pair of protective glasses 120, in accordance with the present disclosure. In this example, a pair of surgical magnifiers 130 are also attached to the protective glasses 120.

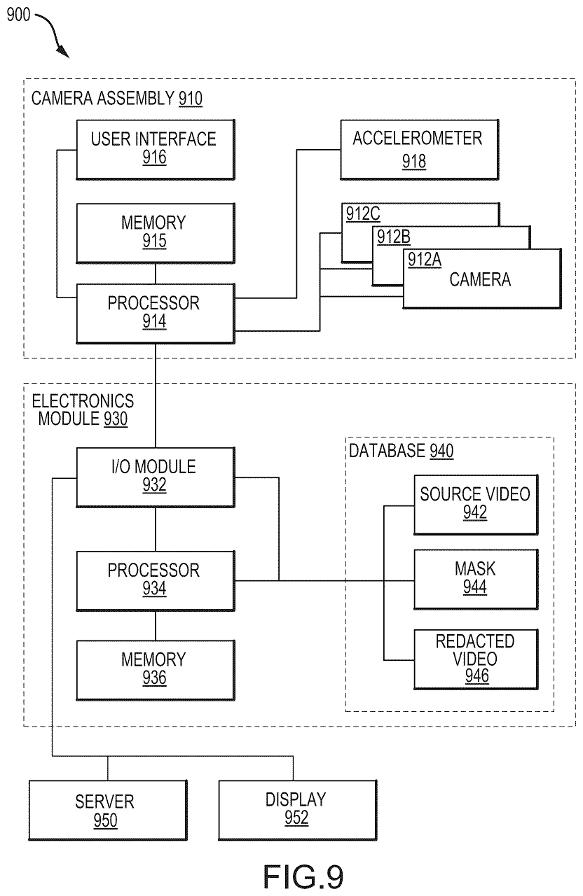

The camera system 300 comprises a camera assembly 310 that is communicatively connected to an electronics module 320. In certain embodiments, the camera assembly 310 has a FOV 312 characterized by a line of sight (LOS) 314. In certain embodiments, the LOS 314 is a centerline of the FOV 312. Although the FOV 312 is shown with a conical form in FIG. 3, the FOV 312 may have any shape or form, e.g., a rectangle, with either straight or curved sides. In certain embodiments, the electronics module 320 is electrically connected to a belt-worn module (not visible in FIG. 3) that comprises one or more of a power source, a processor, a memory, a communication module, and a user interface. In certain embodiments, the camera assembly 310 and/or the electronics module 320 comprises an accelerometer 918 (FIG. 9). The accelerometer 918 (FIG. 9) can be configured to measure motion of the camera assembly 310 and/or report one or more of the 3D position and/or orientation of the camera's LOS 314 and/or the FOV 312.

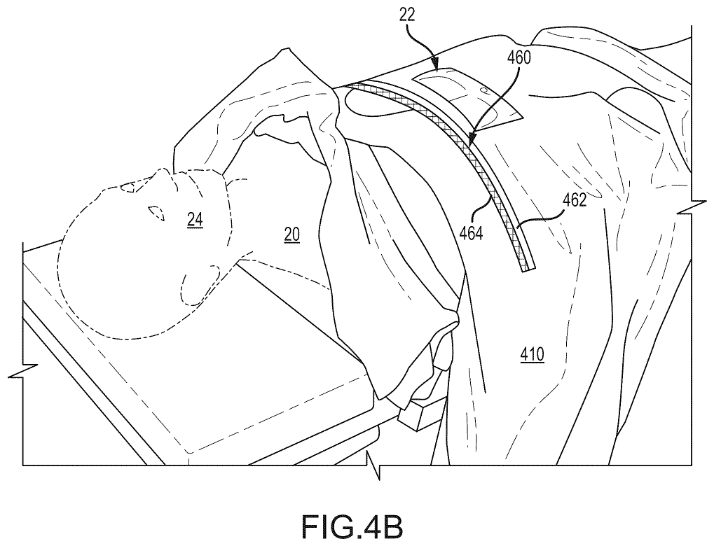

FIG. 4A depicts a draped surgical site 400 with exemplary markers 420, 430, 440 disposed proximate to the site, in accordance with the present disclosure. In this example, drapes 410 have been placed over a patient 20, thereby exposing an area of the patient. Exemplary marker 420 is placed proximate to one edge of the exposed area and can comprise one or more of a “bullseye” target 422, a striped portion 424, and/or a shaded portion 426. In certain embodiments, the marker 420 can comprise a machine-identifiable feature that can enable determination of a position and/or orientation of the marker 420 and/or an identification of the marker 420.

Exemplary marker 430 can comprise a data matrix code, such as a “2D barcode,” which can comprise information associated with one or more of the patient 20, the operation, the staff, and/or the location of the surgical site 400 relative to the marker 430. Exemplary marker 440 can comprise a linear barcode, such as a “1D barcode,” which can comprise information associated with one or more of the patient 20, the operation, the staff, and/or the location of the surgical site 400 relative to the marker 440.

In certain embodiments, an area of interest 22, e.g., the exposed portion of patient 20, can be identified. The area of interest 22 can be identified rather than or in addition to identifying areas of exclusion. In certain embodiments, creation of a redacted video can comprise masking the portions of the video frames that do not correspond to the area of interest 22. In certain embodiments, the area of interest 22 can be indicated, at least in part, by a boundary marker 450. The boundary marker 450 can, in the exemplary embodiment of FIG. 4A, comprise a strip of material placed along one or more edges of the area of interest 22. In certain embodiments, the boundary marker 450 can comprise a background having a known color or pattern and one or more symbols 452. The one or more symbols 452 can indicate a direction, e.g., chevrons that are understood to point in the direction of the “V” tip. In certain embodiments, the directional symbols can point toward the area of interest 22. In certain embodiments, one or more adjacent boundary markers 450 can be connected or overlapped, e.g., at the corners of an (i.e., rectangular) area of interest 22. In this manner, a continuous boundary around the area of interest 22 can be formed. In certain embodiments, a boundary marker 460 can comprise two adjacent regions 462, 464 having different characteristics, e.g., different colors or different patterns. The stored information about boundary marker 460 can define the direction toward the area of interest 22. For example, in the embodiment of boundary marker 460 shown in FIG. 4A, the arrangement of region 464 with respect to region 462 is predetermined to indicate a direction. Stated another way, parallel regions 462, 464 are defined such that moving from region 464 toward region 462 defines a direction toward the area of interest 22. In certain embodiments, a boundary marker 470 can include both color/patterned stripes 472, 474, similar to regions 462, 464 discussed with respect to boundary marker 460, and one or more symbols 476, similar to the one or more symbols 452 discussed with respect to boundary marker 450.

FIG. 4B depicts a draped patient 20 with an exemplary boundary marker 460 disposed between the area of interest 22 and the patient's face 24, in accordance with the present disclosure. The boundary marker 460 can comprise a region 464 comprising a color band and a region 462 comprising a reference, e.g., white, band. In certain embodiments, the color band can be a predetermined first color, e.g., red, that indicates that everything past the color band in a direction away from reference band should be redacted. In certain embodiments, the color band can be a predetermined second color, e.g., yellow, that indicates that there is an area of exclusion at a defined distance from the color band in a direction away from reference band that should be redacted. In certain embodiments, the defined distance may not be a precise value. Rather, the defined distance can indicate that, as the source video image moves away from the color band in a direction away from the reference band, frames of the source video in which the color band is no longer visible should be redacted. For example, portions of the source video that show only the drapes that are covering the patient can be deleted from the redacted video. In this manner, the redacted video can be shortened to include only those segments that contain information of interest to the intended audience. In certain embodiments, a boundary may be defined dynamically to be either a physical or virtual means. In certain embodiments, the user draws a line with a marker, for example black or other color, while the camera is capturing the raw video. In post-processing, the system can comprise a mode during which the system can recognize the line being drawn as a boundary and can store the line in memory for use during redaction. In certain embodiments, a person viewing the raw video can use a “virtual pen” or other computer user interface, e.g., a touchscreen, to indicate the boundary within the displayed image and the system can store this boundary for use in redacting the video signal.

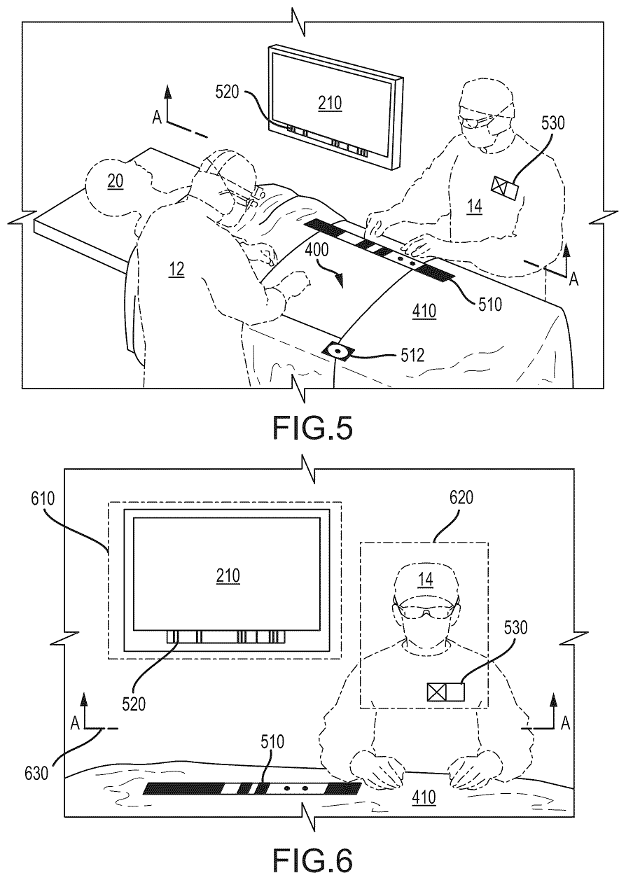

FIG. 5 depicts an operation in progress with exemplary markers 510, 512, 520, 530 disposed on equipment 210, staff member 14, and the patient 20, in accordance with the present disclosure. Markers 510, 512 can be disposed on the drapes 410 covering the patient 20 and proximate to the surgical site 400. Marker 520 can be attached to a display 210, for example, on a side visible to the surgeon 12. Marker 530, i.e., a badge, can be attached to a staff member 14.

FIG. 6 depicts exemplary areas of exclusion 610, 620, 630 respectively associated with markers 520, 530, 510 and/or the orientation of the camera, in accordance with the present disclosure. In certain embodiments, marker 520 can be placed in a known location on the display 210. An area of exclusion 610 can be defined relative to the marker 520, for example when viewed from the front, e.g., the surface on which the marker 520 is attached. In certain embodiments, the area of exclusion 610 can cover the entire display 210. In certain embodiments, the area of exclusion 610 can cover a portion of the display 210, i.e., a portion of the display 210 that displays the patient's name. The area of exclusion 610 may not cover other parts of the display 210, i.e., a portion of the display 210 that displays vital signs or other data relevant to the use of the recorded video. In certain embodiments, one or more of markers 520, 530 can include a directional symbol, i.e., the symbol 452 of boundary marker 450 in FIG. 4A. The direction symbol can provide information related to the position of the respective areas of exclusion 610, 620.

In certain embodiments, it may be desirable to obscure the identity of a staff member 14 who is present at the operation, e.g., an observer such as a resident. In certain embodiments, the size and position of the area of exclusion 620 relative to the marker 530 can be known, e.g., stored in a memory of a server in communication with the camera system. In certain embodiments, marker 530 comprises information that indicates the marker 530 is attached to a person. In such cases, the camera system can use another method, i.e., facial recognition, to dynamically locate identifying information, e.g., the face of the person. The area of exclusion 620 can be established based, at least in part, on the located identifying information. In certain embodiments, the camera system can track the movement of staff member 14 and can relocate the area of exclusion 620, i.e., to continuously include the located identifying information.

In certain embodiments, it can be desirable to exclude all video that is above a predetermined level in the FOV of the camera, for example, as shown in FIGS. 5 and 6 above the boundary line A-A. In certain embodiments, the location of boundary A-A can be determined by a predetermined offset distance from the observed location of marker 510. The marker 510 can be located on the patient 20, for example, proximate to the surgical site 400. In certain embodiments, the location of boundary A-A is determined by a predetermined offset distance from the observed location of marker 520 and/or another marker which is located in a known location above boundary line A-A. In certain embodiments, the location of boundary line A-A can be determined by an angle of the LOS 314 (defined in FIG. 3) exceeding a threshold value.

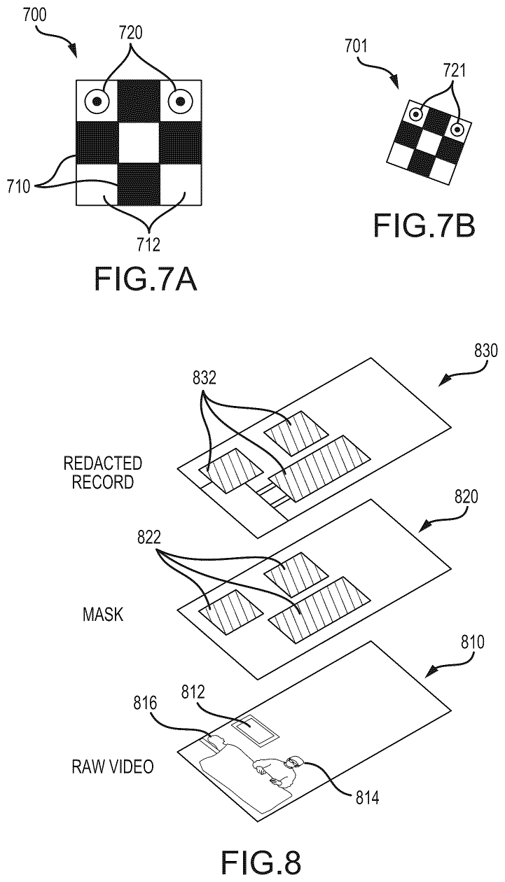

FIG. 7A depicts an exemplary marker 700. Marker 700 can be configured to enable image analysis to determine a distance, in accordance with the present disclosure. In certain embodiments, a portion of marker 700, e.g., the black squares 710 and the white squares 712, can be configured to enable an image-identification algorithm to identify the marker 700, i.e., the marker 700 is configured to be machine-identifiable, and/or to extract certain features, e.g., a boundary between a black square 710 and a white square 712.

In certain embodiments, the marker 700 can comprise one or more scaling features, i.e., the (e.g., bullseye) targets 720. Targets 720 can be positioned with a known separation distance between a first target 720 and a second target 720. In certain embodiments, an image-processing algorithm can utilize an identified distance between the targets 720 in the camera image, information, e.g., a record stored in a connected memory, about the known separation distance between the targets 720, and/or characteristics of the camera optics to determine the distance of the marker 700 from the camera. In certain embodiments, the scaling features can comprise one or more geometric elements or any other graphic element configured to be measured by an image-processing algorithm.

FIG. 7B depicts a marker 701. Marker 701 can be identical to marker 700 and can be disposed at greater distance from the observer, e.g., a camera, than marker 700 is in FIG. 7A. In certain embodiments, the image-processing algorithm can determine the identified distance between targets 721 while marker 701 is rotated with respect to marker 700. The identified distance between the targets 721 of marker 701 is smaller than the identified distance between targets 720 in response to the marker 701 being further from the observer than the marker 700. The image-processing algorithm will determine, based at least in part on the identified distance between targets 720 and/or targets 721, that marker 701 is further from the camera than marker 700.

FIG. 8 schematically depicts the relationship between a source frame 810 of a source video, a frame mask 820, and an output frame 830 of a redacted video, in accordance with the present disclosure. The source frame 810 can include elements such as a display 812 containing PHI, e.g., the patient's name, the face and badge of a staff member 814, and the head of the patient 816. Each of these elements can have a marker as described herein, such as for example marker 520 of FIG. 5. The marker can be positioned proximate to the element (not visible in source frame 810). In certain embodiments, it can be desirable to redact one or more of the elements of the source frame 810. The image-identification algorithm can identify each marker and can determine the position of the marker within the source frame 810. In certain embodiments, the image-identification algorithm can extract a unique identifier from each of the markers and can use the unique identifiers to retrieve information, which describes a respective area of exclusion and/or a spatial relationship of the marker to the respective area of exclusion.

In certain embodiments, a frame mask 820 can be created for each source frame 810. The image-processing algorithm can identify a portion of the source frame 810 that corresponds to each area of exclusion and can create a masking area 822 in frame mask 820 for each area of exclusion.

In certain embodiments, the source frame 810 and the frame mask 820 are saved in a non-transient memory so as to preserve the original source video for future reference and save the frame mask 820 for audit. In certain embodiments, the source video is saved in encrypted form or otherwise secured as it contains PHI. In certain embodiments, information that defines the masking areas 822 of each frame mask 820 is stored, e.g., as corner coordinates of the masking area 822, in place of the frame mask 820 to conserve memory space.

In certain embodiments, the frame mask 820 and the source frame 810 can be combined to create the output frame 830. Each portion of the output frame 830 that corresponds with a masking area 822 can be obscured. In certain embodiments, creation of the frame mask 820 can be skipped and the output frame 830 can be created directly from the source frame 810 by obscuring the portions of the output frame 830 that correspond to the areas of exclusion 832. In certain embodiments, the output frame 830 can be saved in a non-transient memory. In certain embodiments, the output frame 830 does not contain information, e.g., prior versions or a processing history, that can be used to retrieve or reconstruct the portions of the source frame 810 that have been obscured.

FIG. 9 depicts a block diagram 900 of an exemplary system configured to capture source video and create a redacted video, in accordance with the present disclosure. The system can include a camera assembly 910 and an electronics module 930. The electronics module 930 can be connected to an external server 950 and/or a display 952. In certain embodiments, functional elements are provided in alternate locations, separated into multiple elements, or combined to accomplish the same system function.

The exemplary camera assembly 910 can include one or more cameras 912A, 912B, 912C. The one or more cameras 912A, 912B, 912C can be communicatively coupled to a processor 914. Processor 914 can have a communicatively coupled memory 915. In certain embodiments, the camera assembly 910 can have a user interface 916, e.g., a push button or a light emitting diode (LED). The user interface 916 can provide an input to the processor 914 and/or provide information to the user. In certain embodiments, the one or more cameras 912A, 912B, 912C are not identical, e.g., each of the one or more cameras 912A, 912B, 912C can have a unique range of focus. In certain embodiments, the one or more cameras 912A, 912B, 912C can have different F-stops and/or shutter speeds.

The exemplary electronics module 930 can include an input/output (I/O) module 932. The I/O module 932 can be communicatively coupled to the processor 914 of the camera assembly 910. The processor 934 can be communicatively coupled to an electronic memory 936, e.g., a hard disk, a solid-state drive (SSD), a RAM device, a ROM device, or other computer storage medium, and/or a database 940. In certain embodiments, the memory 936 and the database 940 are both provided by a common device, e.g., an SSD. In certain embodiments, the memory 936 and the database 940 can be located in the server 950. The database 940 can store one or more of the source video 942, the frame mask 944, and/or the redacted video 946. In certain embodiments, the processor 934 can be communicatively coupled to an (e.g., external) server 950 and an (e.g., external) display 952, e.g., a video screen in an OR observation area. In this manner, a near-real-time view of the source video 942 or the redacted video 946 may be provided. In certain embodiments, the I/O module 932 can comprise a user interface element, e.g., a stop/start button.

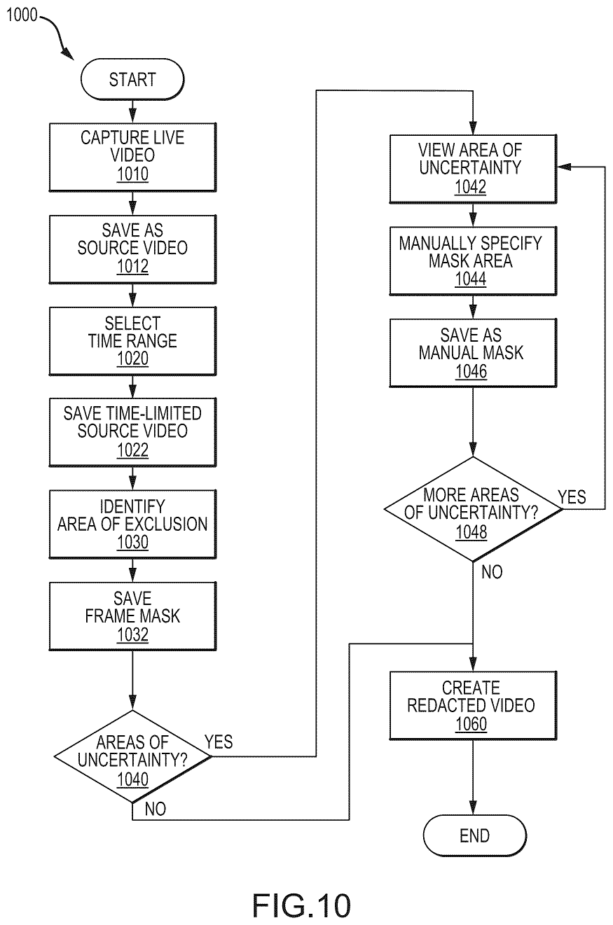

FIG. 10 depicts a flowchart of an exemplary process 1000 to capture raw video and create a redacted video, in accordance with the present disclosure. The process starts with step 1010 including capturing live video from one or more cameras. The live video can be is stored as a source video, for example in a non-volatile memory, in step 1012. In certain embodiments, step 1010 includes retrieving a previously captured source video from a memory and step 1012 can be skipped. In certain embodiments, a time range corresponding to a portion of the source video can be selected in step 1020 and the portion of the source video corresponding to the selected time range can be stored in step 1022. Step 1030 can include identifying one or more areas of exclusion in the source video and/or the time-limited source video, e.g., as described with respect to FIGS. 5 and 6. In certain embodiments, a frame mask containing the areas of exclusion can be created and/or stored in step 1032.

Step 1040 can include checking whether any areas of uncertainty are present in the source video. An exemplary area of uncertainty can include a display identified by the image-analysis algorithm which is not fully contained within the area of exclusion associated with the marker attached to the display, wherein there is a possibility that the portion of the display not contained within the area of exclusion may include PHI. Another example of uncertainty can include a face, i.e., of either a patient or staff member, which is flagged by the image-analysis algorithm but is not associated with a marker, for example because the marker is not visible due to motion of the individual. An area of uncertainty can also be a portion of the source video that has been obscured that does not include PHI, e.g., the designated site of the operation. In such cases, the obscuration can diminish the value of the redacted video. If there are areas of uncertainty, determined either by the image-analysis algorithm or by a manual review of the redacted video, the process can branch to steps 1042-1048. Step 1042 can include a user viewing each area of uncertainty. Step 1044 can include the user manually specifying a masking area and/or adjusting an existing masking area. Step 1046 can include saving the new or revised masking area, e.g., saving as part of a revised frame mask.

If there are no areas of uncertainty identified in step 1040, or after steps 1042-1048, the process can advance to step 1060. Step 1060 can include creating the redacted video and, in certain embodiments, storing the redacted video in a non-volatile memory. In certain embodiments, a portion of step 1060 can be executed prior to step 1040 so that the preliminary redacted video can be reviewed, i.e., to identify areas of uncertainty. In an example embodiment, the step 1060 may be taken both prior to step 1040 and then again after step 1048.

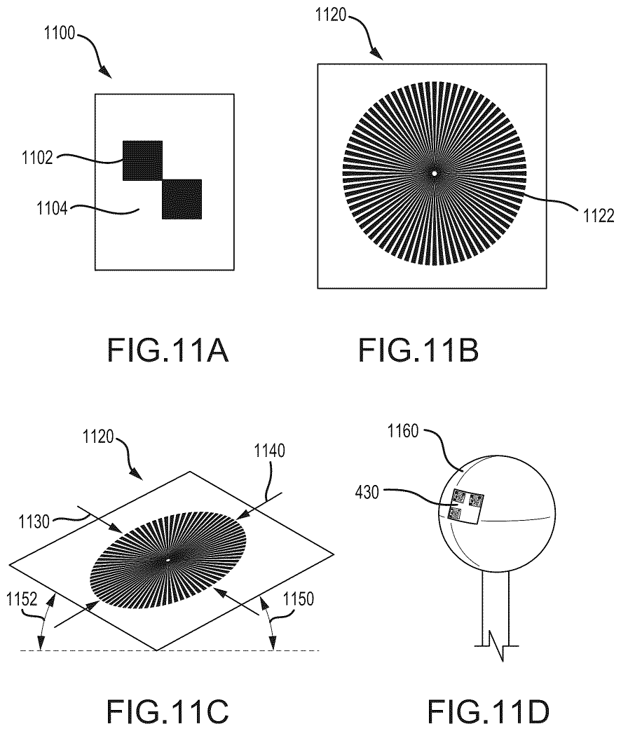

FIG. 11A depicts an exemplary focus target 1100, in accordance with the present disclosure. The focus target 1100 can include two black squares 1102 and one or more (i.e., two) white regions 1104. A focal metric can be calculated using these black squares 1102 and white regions 1104. Although described as white and black, the squares 1102 and the regions 1104 can be any contrasting colors. The calculated focal metric can reflect how well focused the image of the focus target 1100 is in the evaluated source video.

Inclusion of a focus target in a marker, or as a stand-alone element, can enable the system to maintain the designated site, or other portion of the camera FOV, in focus in response to movement, for example, of a surgeon wearing the camera assembly. Conventionally, this is accomplished with an auto-focus component of a camera. An undesirable result of an auto-focus system is that the system must search to find the setting that provides a focused image of the designated site, thereby resulting in a video that occasionally becomes very blurry as the auto-focus system attempts to adjust the focus.

The disclosed system can include a plurality of cameras, e.g., cameras 912A, 912B, 912C of FIG. 9, each having a fixed focus for a different range of distances. In certain embodiments, two cameras have different ranges of focus, i.e., the distance from the camera to the element being observed when the image of the element is in focus. The ranges of focus can overlap. In certain embodiments, the ranges of focus do not overlap. In certain embodiments, an image is considered “in focus” over a range of distances. In certain embodiments, a focal metric can be calculated and the image can be considered in focus when the focal metric is within a predetermined range, e.g., above a threshold value. In certain embodiments, focal metrics can be calculated for a plurality of frames and the desired (e.g., best) focal metric is identified as having the highest value. In certain embodiments, the desired focal metric is identified as being the closest to a target value. In certain embodiments, the focal metric is any of autofocus methods of determining the degree of focus of an image, e.g., phase detection and contrast detection.

In certain embodiments, the “observing camera” can comprise a plurality of fixed-focus cameras. In certain embodiments, the optics of the plurality of cameras can be configured such that the depth-of-field (DOF) over which an object is in acceptable focus is large enough to capture the area of interest while (i.e., inherently) blurring objects that are farther way, e.g., a surgical information display positioned several feet beyond the surgical table. Creating a redacted video from the plurality of source videos from the plurality of cameras by selecting the source video in which the area of interest is in the best focus can result in blurring of objects outside the selected DOF.

In certain embodiments, the marker can comprise a scaling feature, such as targets 720 shown in FIG. 7A. In certain embodiments, the distance of the scaling feature from the camera is calculated from the image of the scaling feature in the source video. When there are multiple cameras, each camera can be associated with a predetermined range of focus and the source video to be copied to the output video can be selected based on a comparison of the calculated distance from a camera to an object and the known ranges of focus for the various cameras. In certain embodiments, the distance from the camera to an object is determined by a distance determination method, e.g., an ultrasonic or laser time-of-flight measurement.

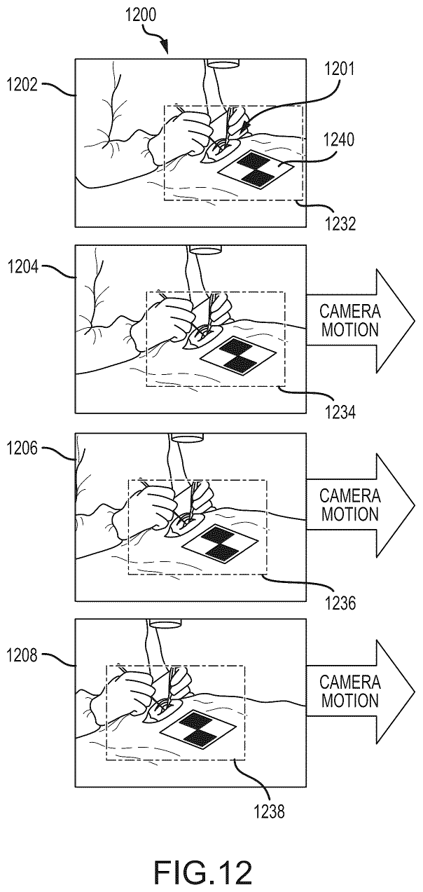

In certain embodiments, the plurality of cameras can be mounted such that their respective LOSs are parallel and their respective FOVs overlap. In certain embodiments, the plurality of cameras are configured and arranged such that switching from the source video of one camera to the source video of a different camera causes a negligible change of the image, i.e., a small motion artifact. In certain embodiments, the disclosed system can compensate for a motion artifact caused by switching between the source videos from different cameras, for example by image stabilization as discussed below with respect to FIG. 12.

In certain embodiments, the plurality of source videos from multiple cameras can be chronologically synchronized and the frames of the source videos can be time stamped such that each source video has a frame having a common time stamp. In certain embodiments, focal metrics can be calculated for each frame of each of the source videos from a respective plurality of cameras. In certain embodiments, selection of which source video to copy to the output video can be based on a comparison of the respective focal metrics for the frames having a common time stamp. In certain embodiments, the focal metric is calculated only for the portion of the source video that contains the focal element (i.e., the area of interest and/or a target or marker).

In certain embodiments, the plurality of cameras can be configured with differences in other settings, e.g., F-stop, aperture, or shutter speed. For example, there may be changes in the illumination of the designated site during an operation, for example, caused by adjustments in the surgical light sources and/or the surgeon moving closer to or further from the designated site, which can cause the illumination of the designated site to be too bright or too dark. In such cases, a single fixed-setting camera may provide a video wherein the designated area is overexposed or underexposed such that details are rendered unobservable. In certain embodiments, the disclosed system creates an output video in which the visibility of the designated site is maintained by switching between the source videos of cameras having different settings. In this manner, the resulting output video is maintained in the predetermined range of acceptable brightness.

FIG. 11B depicts another focus target 1120. Focus target 1120 can be formed from a plurality of wedges 1122 arranged in a radial pattern. As with focus target 1100, image-analysis algorithms can calculate a focal metric that reflects the degree of focus of an image of the focus target 1120.

FIG. 11C depicts focus target 1120 as seen from an oblique angle, for example the viewing angle of the surgeon 12 in FIG. 5. In certain embodiments, a direction from the observing camera to the focus target 1120 can be calculated based on measurement of attributes of the focus target 1120 that are known. In the example of FIG. 11C, the focus target 1120 appears as an oval in the FOV of an observing camera. Measurement of the minor axis diameter 1130 and major axis diameter 1140 and the apparent angles 1150, 1152 in the FOV, for example by image-processing software, can be used to calculate one or more possible 3D vectors from the focus target 1120 to the observing camera. In certain embodiments where evaluation of a single focus target 1120 does not provide an unambiguous 3D vector, another factor, e.g., a position of a second target (not shown in FIG. 11C), can additionally be used to identify the true 3D vector from the observing camera to the focus target 1120.

In certain embodiments, a distance from the observing camera to the focus target 1120 can be calculated based on measurement of attributes of the focus target 1120 that are known. For example, the minor axis diameter 1130 and the major axis diameter 1140 and the apparent angles 1150, 1152 in the FOV can be used to determine the apparent diameter of focus target 1120 if it were disposed perpendicular to the LOS of the observing camera. In an example embodiment, the system can be configured to compare the apparent diameter to the known actual diameter, in conjunction with knowledge of the optical design of the camera, to enable determination of the distance between the focus target 1120 and the observing camera.

FIG. 11D depicts an exemplary focus target 1160 that can enable an angle-independent reference measurement. In certain embodiments, focus target 1160 is configured as a sphere and measurement of the apparent diameter of the focus target 1160 can produce the same value (i.e., regardless of the angle of the observing camera). In certain embodiments, the focus target 1160 can include a machine-readable identifier, e.g., marker 430 (FIG. 4A), which can encode a unique identifier associated with the focus target on which it is mounted. In an example embodiment, the system can be configured to use the measured apparent diameter in conjunction with the known actual diameter to calculate the distance from the camera to the focus target 1160, which can then be utilized as discussed above to maintain focus, stabilize the video, and/or compensate for movement of the camera.

FIG. 12 depicts an exemplary process 1200 of stabilizing a video, in accordance with the present disclosure. FIG. 12 depicts a chronological series of source frames 1202, 1204, 1206, 1208. In the chronological series of source frames 1202, 1204, 1206, 1208, camera motion, indicated by the arrows, causes the FOV to sweep across a designated area 1201, e.g., a surgical site. Motion of the designated area 1201 in the video can be distracting and/or make it difficult to observe the procedure. In this example, a marker 1240 is positioned proximate to the designated area 1201 and is visible in each source frame 1202, 1204, 1206, 1208. In certain embodiments, the marker can include a tracking feature. For example, the point of contact of the two black squares of marker 1240 can form a tracking feature.

In certain embodiments, the processed video record can be stabilized by selecting a portion of each frame of the source video to be included in the processed video record, wherein the selected portion is smaller (i.e., has a lesser area) than the full frame of the source video. In this example, an output frame 1232 is chosen with an area that is smaller than the area of the respective source frame 1202. The size of the output frame can be constant over the chronological series of source frames 1202, 1204, 1206, 1208. The position of the output frame within each source frame can change. In this manner, the position of the marker 1240 can be approximately the same in each of the output frames 1232, 1234,1236, 1238.

In certain embodiments, only certain time portions of a source video are desirably stabilized. For example, a surgeon wearing a camera will look in various directions over the course of a procedure and it may be desirable for the output video to exclude such look-away segments while retaining segments wherein the surgeon is continuously looking at the designated site. In certain embodiments, the segments to be retained can be determined by the presence of one or more of the markers being within the FOV of the source video. In certain embodiments, the segments to be deleted or redacted can be determined by the lack of one or more of the markers being within the FOV of the source video. In certain embodiments, the portions of the source video that are not selected to be stabilized can be cropped to the size of the output frame (i.e., of the stabilized portions of the source video) and may then be copied into the output video. In certain embodiments, the position of the output frame in the non-stabilized source frames can be selected to match the position of the frame in a chronologically adjacent stabilized frame. In this manner, image “jumping” when transitioning between stabilized portions and cropped-but-not-stabilized portions may be reduced and/or avoided.

In certain embodiments, it can be desirable to maintain the apparent size of the designated area 1201 within a limited range or with a reduction in the apparent movement of the camera toward or away from the designated area 1201, e.g., to improve a viewer's ability to observe a surgical procedure. Once a distance of the camera from the marker 1240 is known, as discussed with respect to FIG. 11C, the size of output frames 1232, 1234, 1236, 1238 may be modified to maintain the size of marker 1240 and the adjacent designated area 1201 at approximately the same size.

In certain situations, it can be desirable to adjust the camera to actively compensate for movement of the camera. In certain embodiments, the apparent size of one or more attributes of marker 1240 can be measured and provided to a feedback control system. The feedback control system can compare the latest apparent size to a reference, e.g., a moving average of prior measurements, and can send a signal to the camera to adjust its magnification. In certain embodiments, the user can provide an input that identifies a pair of markers, e.g., a pair of markers 700 and/or spherical targets 1160, that are fixedly attached to a stable object, e.g., a table, such that the distance between the markers remains constant and can be used by the system during post-processing as a fixed distance reference, for example, to scale the size of the designated area 1201 or maintain focus.

### SUMMARY

In summary, the disclosed apparatus and methods can produce a redacted output video from one or more source videos that contain PHI, create an output video that is continuously in focus despite changes in the distance of the camera from a designated site, and can stabilize the images of an output video to compensate for motion of the camera. These capabilities may be provided in combination with each other or separately.

### Embodiments

A1. A method of redacting a source video, comprising steps of receiving with a processor a frame of the source video; identifying with an image-identification algorithm running on the processor a marker within the frame of the source video, wherein the marker is machine-identifiable; retrieving from an electronic memory information comprising a description of an area of exclusion and a spatial relationship of the marker to the area of exclusion; identifying with an image-processing algorithm running on the processor a portion of the frame of the source video that corresponds to the area of exclusion; and creating an output frame of a redacted video that corresponds to the frame of the source video by obscuring the portion of the frame of the source video.

A2. The method of A1, wherein: the marker comprises an identifier, wherein the identifier is machine-readable; the step of identifying the marker comprises extracting the identifier from an image of the marker; and the step of retrieving information comprises utilizing the identifier to select a record associated with the identifier from one or more records stored in a database.

A3. The method of A1, wherein: the marker comprises a machine-identifiable feature that enables determination of a position of the marker; and the step of identifying the marker comprises determining the position of the marker using the image-processing algorithm.

A4. The method of A1, wherein: the marker comprises a scaling feature; and the information retrieved from the database comprises a description of the scaling feature that enables identification of a size and location of the area of exclusion within the frame of the source video.

A5. The method of A1, further comprising: associating a frame mask with the frame of the source video; and identifying a masking area within the frame mask that corresponds to the area of exclusion; wherein: the step of creating the output frame comprises combining the frame mask with the frame of the source video such that the masking area of the frame mask obscures a corresponding portion of the source video.

A6. The method of A5, wherein: the frame of the source video and the frame mask are saved in a non-transient memory; and the frame of the source video is saved in an encrypted form.

A7. The method of A1, wherein the source video was created by a camera utilized during a medical procedure.

A8. The method of A1, wherein the source video comprises protected health information (PHI).

B9. A machine-readable, non-volatile memory comprising instructions that, when loaded into a processor and executed, cause the processor to perform steps: receiving with a processor a frame of a source video; identifying with an image-identification algorithm running on the processor a marker within the frame of the source video, wherein the marker is machine-identifiable; retrieving from an electronic memory information comprising a description of an area of exclusion and a spatial relationship of the marker to the area of exclusion; identifying with an image-processing algorithm running on the processor a portion of the frame of the source video that corresponds to the area of exclusion; and creating an output frame of a redacted video that corresponds to the frame of the source video by obscuring the portion of the frame of the source video.

B10. The memory of B9, wherein: the marker comprises an identifier, wherein the identifier is machine-readable; the step of identifying the marker comprises extracting the identifier from an image of the marker; and the step of retrieving information comprises utilizing the identifier to select a record associated with the identifier from one or more records stored in a database.

B11. The memory of B9, wherein: the marker comprises a machine-identifiable feature that enables determination of a position of the marker; and the step of identifying the marker comprises determining the position of the marker using the image-processing algorithm.

B12. The memory of B9, wherein: the marker comprises a scaling feature; and the information retrieved from the database comprises a description of the scaling feature that enables identification of a size and location of the area of exclusion within the frame of the source video.

B13. The memory of B9, comprising further instructions that, when loaded into the processor and executed, cause the processor to perform steps: associating a frame mask with the frame of the source video; identifying a masking area within the frame mask that corresponds to the area of exclusion; and combining the frame mask with the frame of the source video such that the masking area of the frame mask obscures a corresponding portion of the source video.

B14. The memory of B13, wherein: the frame of the source video and the frame mask are saved in a non-transient memory; and the frame of the source video is saved in an encrypted form.

C15. A method of maintaining focus of a designated site in a video record, comprising steps: receiving with a processor a plurality of source videos from a respective plurality of cameras each having a different focal range, wherein each source video comprises a chronological series of frames each having a corresponding time stamp; identifying with an image-processing algorithm running on the processor a frame of each of the plurality of source videos that corresponds to a selected time; calculating with the image-processing algorithm a focal metric for each of the identified frames of the plurality of source videos; determining with the image-processing algorithm which of the identified frames has a desired focal metric; and saving the determined frame.

C16. The method of C15, wherein: the plurality of source videos are chronologically synchronized such that each of the plurality of source videos comprises a respective frame having a common time stamp.

C17. The method of C16, further comprising the step: placing a marker comprising a focus feature proximate to the designated site; wherein: the focal metric is calculated only for a portion of the identified frames restricted to an image of the focus feature.

C18. The method of C15, wherein: the plurality of cameras are disposed proximate to each other; and the respective lines-of-sight (LOSs) of the plurality of cameras are approximately parallel.

D19.A method of stabilizing a video record, comprising: receiving with a processor a source video comprising a chronological series of source frames; selecting from the source video a set of source frames to be stabilized, wherein the set of source frames are chronologically sequential; identifying an image-processing algorithm running on the processor a position of a tracking feature in each source frame of the set of source frames; selecting with the image-processing algorithm an output frame for each source frame in the set of source frames such that the position of the tracking feature is the same within each output frame; and saving the selected output frames.

D20. The method of D19, wherein: the tracking feature comprises a scaling feature; and the second area is adjusted in size for one or more of the source frames in the set of source frames such that the scaling feature has a constant apparent size in the output frames of the video record that correspond to the set of source frames.

D21. The method of D19, wherein: the steps of identifying the tracking feature, selecting the output frame, and saving the selected output frames are performed only on the set of source frames.

D22. The method of D19, wherein: each of the source frames have a first area, each of the output frames have a second area that is smaller than the first area, each of the source frames that are not selected to be stabilized are cropped to the second area to form cropped source frames, and each of the cropped source frames are saved as part of the video record.

D23. The method of D22, wherein: the tracking feature comprises a scaling feature, and the second area is adjusted in size for one or more of the source frames in the set of source frames such that the scaling feature has a constant apparent size in the output frames of the video record that correspond to the set of source frames

D24. The method of D21, wherein: a position of the second area relative to the first area of a cropped source frame that is chronologically adjacent to the set of source frames selected to be stabilized matches the position of the second area relative to the first area of a chronologically adjacent source frame.

D25. The method of D19, wherein selecting the set of source frames is performed by: determining the position of the tracking feature in each source frame of the source video, identifying a continuous sequence of source frames wherein the tracking feature remains within a predetermined third area, and choosing a portion of the continuous sequence of source frames to be the set of source frames.

D26. The method of D19, wherein selecting the set of source frames is performed manually.

Headings and subheadings, if any, are used for convenience only and do not limit the invention.

Reference to an element in the singular is not intended to mean “one and only one” unless specifically so stated, but rather “one or more.” Use of the articles “a” and “an” is to be interpreted as equivalent to the phrase “at least one.” Unless specifically stated otherwise, the terms “a set” and “some” refer to one or more.

Terms such as “top,” “bottom,” “upper,” “lower,” “left,” “right,” “front,” “rear” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference without limiting their orientation in other frames of reference.

Although the relationships among various components are described herein and/or are illustrated as being orthogonal or perpendicular, those components can be arranged in other configurations in some embodiments. For example, the angles formed between the referenced components can be greater or less than 90 degrees in some embodiments.

Although various components are illustrated as being flat and/or straight, those components can have other configurations, such as curved or tapered for example, in some embodiments.

Pronouns in the masculine (e.g., his) include the feminine and neuter gender (e.g., her and its) and vice versa. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “operation for.”

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. A phrase such as an embodiment may refer to one or more embodiments and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

Although embodiments of the present disclosure have been described and illustrated in detail, it is to be clearly understood that the same is by way of illustration and example only and is not to be taken by way of limitation, the scope of the present invention being limited only by the terms of the appended claims.

What is claimed is:

1. A method of redacting a source video, comprising steps:
receiving, at a processor, a frame of the source video;
identifying, by an image-identification algorithm running on the processor, a marker within the frame of the source video, wherein the marker is machine-identifiable;
retrieving, from an electronic memory, information comprising a description of an area of exclusion and a spatial relationship of the marker to the area of exclusion;
identifying, by an image-processing algorithm running on the processor, a portion of the frame of the source video that corresponds to the area of exclusion; and
creating an output frame of a redacted video that corresponds to the frame of the source video by obscuring the portion of the frame of the source video.

2. The method of claim 1, wherein:
the marker comprises an identifier, wherein the identifier is machine-readable;
the step of identifying the marker comprises extracting the identifier from an image of the marker; and
the step of retrieving information comprises utilizing the identifier to select a record associated with the identifier from one or more records stored in a database.

3. The method of claim 1, wherein:
the marker comprises a machine-identifiable feature that enables determination of a position of the marker; and
the step of identifying the marker comprises determining the position of the marker using the image-processing algorithm.

4. The method of claim 1, wherein:
the marker comprises a scaling feature; and
the information retrieved from the database comprises a description of the scaling feature that enables identification of a size and location of the area of exclusion within the frame of the source video.

5. The method of claim 1, further comprising:
associating a frame mask with the frame of the source video; and
identifying a masking area within the frame mask that corresponds to the area of exclusion;
wherein:
the step of creating the output frame comprises combining the frame mask with the frame of the source video such that the masking area of the frame mask obscures a corresponding portion of the source video.

6. The method of claim 5, wherein:
the frame of the source video and the frame mask are saved in a non-transient memory; and
the frame of the source video is saved in an encrypted form.

7. The method of claim 1, wherein the source video was created by a camera utilized during a medical procedure.

8. The method of claim 1, wherein the source video comprises protected health information (PHI).

9. A machine-readable, non-volatile memory comprising instructions that, when loaded into a processor and executed, cause the processor to perform steps:
receiving, at a processor, a frame of a source video;
identifying, with an image-identification algorithm running on the processor, a marker within the frame of the source video, wherein the marker is machine-identifiable;
retrieving, from an electronic memory, information comprising a description of an area of exclusion and a spatial relationship of the marker to the area of exclusion;
identifying, by an image-processing algorithm running on the processor, a portion of the frame of the source video that corresponds to the area of exclusion; and
creating an output frame of a redacted video that corresponds to the frame of the source video by obscuring the portion of the frame of the source video.

10. The memory of claim 9, wherein:
the marker comprises an identifier, wherein the identifier is machine-readable;
the step of identifying the marker comprises extracting the identifier from an image of the marker; and
the step of retrieving information comprises utilizing the identifier to select a record associated with the identifier from one or more records stored in a database.

11. The memory of claim 9, wherein:
the marker comprises a machine-identifiable feature that enables determination of a position of the marker; and
the step of identifying the marker comprises determining the position of the marker using the image-processing algorithm.

12. The memory of claim 9, wherein:
the marker comprises a scaling feature; and
the information retrieved from the database comprises a description of the scaling feature that enables identification of a size and location of the area of exclusion within the frame of the source video.

13. The memory of claim 9, comprising further instructions that, when loaded into the processor and executed, cause the processor to perform steps:
associating a frame mask with the frame of the source video;
identifying a masking area within the frame mask that corresponds to the area of exclusion; and
combining the frame mask with the frame of the source video such that the masking area of the frame mask obscures a corresponding portion of the source video.

14. The memory of claim 13, wherein:
the frame of the source video and the frame mask are saved in a non-transient memory; and
the frame of the source video is saved in an encrypted form.

15. A method of maintaining focus of a designated site in a video record, comprising steps:
receiving, at a processor, a plurality of source videos from a respective plurality of cameras each having a different focal range, wherein each source video comprises a chronological series of frames each having a corresponding time stamp;
identifying, by an image-processing algorithm running on the processor, a frame of each of the plurality of source videos that corresponds to a selected time;
calculating, by the image-processing algorithm, a focal metric for each of the identified frames of the plurality of source videos;
determining, by the image-processing algorithm, which of the identified frames has a desired focal metric; and
saving the determined frame.

16. The method of claim 15, wherein:
the plurality of source videos are chronologically synchronized such that each of the plurality of source videos comprises a respective frame having a common time stamp.

17. The method of claim 16, further comprising the step:
placing a marker comprising a focus feature proximate to the designated site;
wherein:
the focal metric is calculated only for a portion of the identified frames restricted to an image of the focus feature.

18. The method of claim 15, wherein:
the plurality of cameras are disposed proximate to each other; and
the respective lines-of-sight (LOSs) of the plurality of cameras are approximately parallel.

19. A method of stabilizing a video record, comprising:
receiving, at a processor, a source video comprising a chronological series of source frames;
selecting from the source video a set of source frames to be stabilized, wherein the set of source frames are chronologically sequential;
identifying, by an image-processing algorithm running on the processor, a position of a tracking feature in each source frame of the set of source frames;
selecting, by the image-processing algorithm, an output frame for each source frame in the set of source frames such that the position of the tracking feature is the same within each output frame; and
saving the selected output frames.

20. The method of claim 19, wherein:
the tracking feature comprises a scaling feature; and
the second area is adjusted in size for one or more of the source frames in the set of source frames such that the scaling feature has a constant apparent size in the output frames of the video record that correspond to the set of source frames.
